(19) United States
(12) Patent Application Publication
(10) Pub. No.: US 2009/0150292 A1
(43) Pub. Date: Jun. 11, 2009

(54) System and method for secure storing, displaying, organizing electronic, and transferring medical records

(76) Inventors: Dean Trinh, Milptas, CA (US); Dennis Wood, Los Altos, CA (US)

Correspondence Address: WHITE-WELKER & WELKER, LLC, P.O. BOX 199, CLEAR SPRING, MD, 21722-0199, US

(21) Appl. No.: 11/953,795

(22) Filed: Dec. 10, 2007

(51) Int. Cl. G06Q 50/00; H04L 9/32

(52) U.S. Cl. 705/55; 705/3

(57) ABSTRACT

A software application that enables secure storing, displaying, organizing and transferring of electronic medical records (EMR) at a health care provider's office for future visits, storage, billing, insurance audits, and follow up of prescriptions and prescribed treatments. The EMR consists of physician notes, dictation, lab reports, images, patient histories, records, and can be stored and transferred in a plurality of manners. A smart card contains a microprocessor and includes an embedded chip that requires a PIN for access. In use the smart card is accessible by the health care provider entering their key card and PIN as well as the patient entering their own smart card and PIN. The patient then receives updated information on their smart card from their doctor. Next the patient can use the card to provide information to their insurance company, a pharmacy, hospital, or another health care provider.

### FEDERALLY SPONSORED RESEARCH

Not Applicable

### SEQUENCE LISTING OR PROGRAM

Not Applicable

### CROSS REFERENCE TO RELATED APPLICATIONS

Not Applicable

### TECHNICAL FIELD OF THE INVENTION

The present invention relates generally to electronic medical databases. More specifically, the present invention relates to a system and method for secure storing, displaying, organizing, and transferring electronic medical records for use by health care providers.

### BACKGROUND OF THE INVENTION

Electronic smart cards used in health care are not a new invention, as there are eight countries in the world that have already fully integrated their health systems to the cards, and another twenty-one converting to the card system in the very near future, including Greece, Poland and the Czech Republic. The card system was first invented in the mid 1990s, but until this day, is virtually non-existent in the United States. The card saves time and labor by instantly transferring medical information, which also reduces medical error and can be very helpful if a patient is unconscious. In the eight countries where these cards are used, medical error has been reduced anywhere from 25 to 35 percent. The cards are popular abroad because of their efficiency. If the patient and caregiver speak different languages, the card provides a neutral ground for the communication of health history, because information on the card is written in a nearly universal medical code.

The amount just saved in costs alone associated with physically sending medical documents has saved participant countries large amounts of money. The cards have also saved time for patients, who in other systems sometimes have to wait for weeks before the information is transferred traditionally by paper.

No one can argue that today's US health care costs are rising dramatically. Most of the attempts to solve this problem have been based on finding more money to pay for the existing system. With the basic concept of “if it is not broken, don't fix it”, doctors and other health care providers are relying on the paper file system which requires great amounts of time, effort and money rather than embracing electronic filing. Compared to traditional methods of archiving medical history on paper in files, electronic medical file transaction-oriented communication offers numerous, significant benefits, including enhanced productivity, better service, worldwide around-the-clock availability and faster access to a wider range of useful information.

Most doctors are good at making decisions for their patient when the medical records are available and accurate. Data mining from a centralized source of information is considered the key to the success of a patient's treatment and recovery. Providing medical data in an electronic format provides the data mining possibilities to a doctor that would otherwise be unavailable with current paper filing methods.

Many others are developing electronic databases solutions to overcome the deficiencies in the prior art, but the solutions currently known in the prior art all suffer from their own shortcomings that have resulted in a slow adaptation in the marketplace. For example, US Patent Application Publication 2003/0036684 discloses a software system for gathering and managing medical patient information. The system has two components: a first computer module for gathering medical information using medical data entry screens, and a second computer module for creating customized medical data entry screens. The second module can create and customize virtually all aspects of the medical data entry screens. The present invention also allows users to create natural language reports from the medical data that has been gathered, and these reports can be reviewed on the screen or through a printout. Additionally, the data is stored in a database, with unique identifiers assigned to each data point, thereby facilitating data mining. The system also includes a matrix, a unique data entry tool that allows users to easily correlate body parts and modifiers. The system is designed to be used with handheld computing devices, and is especially suitable for use with emergency medical services, although it can be used in a variety of contexts.

US Patent Application Publication 2002/0007287 discloses a system and method for redundantly storing documents, specifically medical records, both on a local computer and on a remote server. A copy of patient data is stored remotely in the event of system problems, and to allow access to patient data from multiple sites. Data is stored on the local computer to speed retrieval of the data at a later date. When data stored on the local computer is newer or the same age as data stored on the remote server, the data is not downloaded from the remote server. If the local data is older than the data on the remote server, the data is downloaded from the remote server. Data may be displayed and organized utilizing a customizable, hierarchical “tree view”. Data may include image files, text files, and information about the files, such as the patient with whom they are associated, the time they were entered into the system, the time of the patient's next appointment, and the like. The client software portion of the present invention may update automatically, or as a result of user interaction. News and other information of interest may be automatically displayed to a user through a connection to the Internet, or through integration with Email, accounting, scheduling, or other systems.

U.S. Pat. No. 7,234,064 teaches a network for mediating the peer-to-peer transfer of digital patient medical data includes a plurality of distributed agents each associated with a health care provider and connected to a central system. Periodically the agents collect local information relating to patient medical files and/or data streams, for example diagnostic images and associated reports, and process that information into metadata files acting as pointers to the original files. The metadata files are transmitted to the central system where they are parsed and the attributes are stored on the central system in patient records with records from the same patient grouped together whenever possible.

U.S. Pat. No. 6,347,329 teaches a medical records system that creates and maintains all patient data electronically. The system captures patient data, such as patient complaints, lab orders, medications, diagnoses, and procedures, at its source at the time of entry using a graphical user interface having touch screens. Using pen-based portable computers with wireless connections to a computer network, authorized healthcare providers can access, analyze, update and electronically annotate patient data even while other providers are using the same patient record. The system likewise permits instant, sophisticated analysis of patient data to identify relationships among the data considered. Moreover, the system includes the capability to access reference databases for consultation regarding allergies, medication interactions and practice guidelines. The system also includes the capability to incorporate legacy data, such as paper files and mainframe data, for a patient.

U.S. Pat. No. 6,151,581 teaches a system and method related to the field of building and administrating a patient management and health care management database containing data relevant to the clinical care of patients, to the management of the practices to which the patients belong, and to outcomes of that health care and practice management. The disclosed system encompasses (i) designing and administering paper and pen and hand held computer survey instruments; (ii) administering and collecting completed surveys (iii) building and managing a database of information collected from the surveys; (iv) analyzing data collected from the surveys; (v) and providing clinical practices with summary information. Summary information may be used to improve patient care, health outcomes, and the management of physician practices.

In the 1990s, the evolution of smart card technology had a dramatic effect on the way people communicated, stored and retrieved secured information. Words and phrases such as online, World Wide Web and the Internet had become part of everyday language, ushering in a new era in communication and with it the next generation of medical informatics was evolved. Today in Europe and Asia, a smart card is a part of everyday life and is embodied in bank cards, ID cards and health cards. In Europe and Asia, the magnetic strip card has virtually disappeared due to its inconsistency, delicateness, and unsecured mechanisms.

U.S. Pat. No. 5,884,271 teaches a universal electronic transaction card (“UET card”) that is capable of serving as a number of different credit cards, bank cards, identification cards, employee cards, medical and health care management cards and the like. The UET card includes storage elements, an input interface, a processor, a display, and a communications interface. In a preferred embodiment, the UET card stores transactional information to eliminate paper receipts and includes security features to prevent unauthorized use. The UET card may also be used to replace conventional currency and traveler's checks, and may be configured to store and display promotional information, such as advertising and incentives.

US Patent Application Publication 2006/0173718 discloses a system for ensuring that a person receives individual-specific health care and avoiding adverse drug reactions, generally comprises: an information card on which critical need medical information, specific to said person, is be stored, and a database that can be electronically accessed by the person so that the person can update their own information stored on the card.

U.S. Pat. No. 5,899,998 teaches a distributed database architecture stores medical information in a self-updating system that employs point-of-service stations disposed at convenient medical service locations. Each patient carries a portable data carrier such as a smart card that contains the patient's complete medical history. Interaction between the portable data carriers and the point-of-service stations effects a virtual communication link that ties the distributed databases together without the need for online or live data connections. The point-of-service stations are also interconnected over a communications network through a switching station that likewise does not rely on online, live communication.

US Patent Application Publication 2006/0173712 discloses a computerized system for monitoring and maintaining the health of a person comprising the steps of (a) obtaining parameter data from the patient and inputting the parameter data into a computer database; (b) analyzing the parameter data using a computerized statistical modeling technique module and a computerized adaptive expert system shell for the prediction of a health event in the lifetime of the patient; (c) using the analyzed data to developed a health maintenance schedule for the patient, and (d) embedding and/or linking such data onto a microprocessor powered smart card.

Small to medium sized clinical practices still utilize the note pad method of prescribing medication but they also have the choice of phoning or faxing in the prescription. Existing problems include fraud, malpractice and death due to lack of feedback and clear communication between the doctor and pharmacist. Currently practiced in Germany, the electronic prescription or ePrescription is stored and carried securely on a smart chip embedded on a plastic card and has practically eliminated the problems seen by traditional prescription.

Not only is the patient's prescription carried securely on this card, but so is other critical information such as allergies, emergency contact information, blood type, doctor last visited and donor rights. Administrative information like electronic payments, electronic data interchange (EDI), electronic order processing, on-line data transfer, medical analysis, accounting by insurance carrier, insurance policy information such as, but not limited to, coverage and terms, medical images and lab reports etc. can easily be carried as well. Small and medium sized data can be carried on a standard smart card but the present invention's high capacity card can carry up to 8 GB of information providing minimal storage limitation. Currently, storage of 128K of information on a standard smart card is the present industry standard but the present invention brought unlimited medical storage capacity onto a card and increased data transfer by 10,000% with its HICAP card. This technology opens health care providers to unlimited possibilities and leaves them to define which method they need and how to integrate it into their business model. None of the existing products offer the health care providers a one-stop affordable solution except the present invention.

The present invention has mapped out the infrastructure support to hospitals, doctors' clinics and all other health care providers on both the supply and demand sides of doctor-to-patient medical history management, making it possible for all of the patient's medical records to travel with the patient securely and effectively to increase productivity while lowering the associated costs. The present invention is able to pro-actively address the needs of the health care provider and building the tools to generate intelligent data from the day-to-day operations in health care commerce is also imperative for an effective reduction in health care cost.

Therefore what is needed is a smart card that provides consistency, robustness, and secured mechanisms for the secure storing, displaying, and organizing electronic medical records.

### SUMMARY OF THE INVENTION

The smart card of the present invention is a password protected health card with a smart chip that can contain and be the key to one's entire medical record and history. All that a health care provider such as a doctor or paramedic has to do to gain full knowledge of a patient's health history is to insert the card into the proper equipment so that it can be read.

The present invention has been designed to enhance the quality of healthcare and reduce medical errors in the medical community while increasingly security and reducing costs. The present invention improves patient care and provides health care providers such as medical doctors, hospitals, pharmacists, and dentists with precise and readily accessible information in a secure and pocket-sized device.

The present invention discloses a turnkey solution based on the joint access of the patients' electronic health file. The supplying of accuracy in health care information will improve the quality of our health care system, making it cost effective for health care professionals, and their patients.

The present invention insures the privacy of patients' health information and is effective in case of an emergency where it can be used as a vital element to save lives providing critical information (allergies, blood type, current medications and so much more).

The present invention is a software application that enables secure storing, displaying, and organizing of electronic medical records (EMR) at a physician's office for future visits, storage, billing, insurance audits, and follow up of prescriptions and prescribed treatments.

The EMR consists of physician notes, dictation, lab reports, images, patient histories, records, and can be stored and transferred in a plurality of manners. The system may use a smart card that contains a microprocessor and is not merely a means for storage of information on a magnetic strip. The smart card has an embedded chip that requires a PIN for access.

In use the smart card is accessible by a health care provider entering his/her key card and PIN as well as the patient entering their own smart card and PIN into the system. The patient then receives updated information on their smart card from their health care provider. Next the patient can use the card to provide information to their insurance company, a pharmacy, hospital, or another health care provider.

A cell phone can also be used to update the removable smart card or transfer or receive information from it. From the software application, a health care provider can enter a patient's cell phone number and send information to the cell phone via the Internet to the system's central server, which is then sent to the patient's cell phone. Once the information has been transferred to the patient's cell phone, the patient must enter a PIN to accept and store the information on their cell phone in the cell phone's memory. Entry of the PIN and acknowledgement of receipt of the information is recorded by the server. If less than 100% of the information is transmitted, no PIN is requested by the patient and the system's central server creates a record of what was and what was not transmitted and/or received thereby creating an auditable trail. No information will remain on the phone if less than 100% of the information is transmitted.

With the information stored on the patient's cell phone there are several methods for transferring the information to the smart card. The first is by using a removable external memory card in the cell phone's card slot, Bluetooth, cable or other equivalent transfer means known in the prior art. The second is for the patient to send an authorization from their cell phone to the system's central server giving permission for the system's central server to send the information to the health care provider's local computer.

The present invention enhances the quality of health care by providing better and faster patient identification during registration and scheduling. This shortens time for patients in the waiting room and the time needed to consult with each patient which results in more patients being seen and evaluated quicker. The present invention also ensures immediate access to administrative costs to insurance companies by reducing paper and administrative workload while enabling an efficient and productive workflow, reduces fraud, and lowers overall health care costs.

The smart card taught by the present invention reduces medical errors by providing available and accurate information that is readable by any health care provider and results in expediting diagnosis and onset of treatment. The information is always available even in situations where the patient is unable to answer, thereby accelerating the speed of medical treatment and saving lives in the case of emergencies.

One objective of the invention is to map out the infrastructure support to hospitals, doctor's clinics and all other health care providers on both the supply and demand sides of doctor-to-patient medical history management.

Another objective of the invention is to teach means for all of a patient's medical records to travel with the patient securely and effectively to increase productivity while lowering the associated costs.

A further objective of the invention is to provide means that pro-actively address the needs of the health care provider.

Yet another objective of the invention is to provide means for building the tools to generate intelligent data from the day-to-day operations in health care commerce to provide an effective reduction in health care cost.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates the patient concentric system of the present invention and the flow of information;

FIG. 2 illustrates the types of EMR transfer of a preferred embodiment of the present invention;

FIG. 3 illustrates the EMR transfer process of a preferred embodiment of the present invention; and

FIG. 4 illustrates the process of transferring the EMR data from a patient's cell phone.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Referring to the figures, it is possible to see the various major elements constituting the apparatus of the present invention. The present invention is a smart card that provides consistency, robustness, and secured mechanisms for the secure storing, displaying, and organizing of electronic medical records to health care providers.

The present invention is a software application that enables the secure storing, displaying, and organizing of electronic medical records (EMR) at a physician's office for future visits, storage, billing, insurance audits, and follow up of prescriptions and prescribed treatments and to other health care providers as necessary.

The EMR consists of physician notes, dictation, lab reports, images, patient histories, records, and can be stored and transferred in a plurality of manners. The system may use a smart card that contains a microprocessor and is not merely a means for storage of information on a magnetic strip. The smart card has an embedded chip that requires a PIN for access.

In use the smart card is accessible by a health care provider entering his/her key card and PIN as well as the patient entering their own smart card and PIN into the system. The patient then receives updated information on their smart card from their health care provider. Next the patient can use the card to provide information to their insurance company, a pharmacy, hospital, or another health care provider.

A cell phone can also be used to update the smart card or transfer or receive information from it. From the software application, a health care provider can enter a patient's cell phone number and send information to the cell phone via the Internet to the system's central server, which is then sent to the patient's cell phone. Once the information has been transferred to the patient's cell phone, the patient must enter a PIN to accept and store the information on their cell phone in the cell phone's memory. Entry of the PIN and acknowledgement of receipt of the information is recorded by the system's central server. If less than 100% of the information is transmitted, no PIN is requested by the patient and the system's central server creates a record of what was and what was not transmitted and/or received thereby creating an auditable trail.

With the information stored on the patient's cell phone there are several methods for transferring the information to the smart card. The first is by using a removable external memory card in the cell phone's card slot, Bluetooth, cable or other equivalent transfer means known in the prior art. The second is for the patient to send an authorization from their cell phone to the server giving permission for the server to send the information to the health care provider's local computer.

The smart card of the present invention has been designed to enhance the quality of healthcare and reduce medical errors in the medical community while increasing security and reducing costs. The purpose of the smart card of the present invention is to improve patient care and provide medical doctors, hospitals, pharmacists, insurance companies, dentists, and other health care providers with precise and readily accessible information in a secure and pocket-sized device.

The present invention provides a turnkey solution based on the joint access of the patient's electronic health file. The supplying of accuracy in health care information will improve the quality of our health care system, making it cost effective for health care providers and their patients.

The smart card of the present invention insures the privacy of the patient's health information and is effective in case of an emergency as a vital element to save lives providing critical information (allergies, blood type, current medications and so much more).

The smart card of the present invention enhances the quality of health care by providing better and faster patient identification during registration and scheduling; ensuring immediate access to detailed medical information on the patient; shortens time for the patient in the waiting room and the time needed to consult with each patient which results in more patients being seen and evaluated quicker; reduces paper and administrative workload while enabling an efficient and productive workflow; reduces medical fraud; and reduces administrative costs to insurance companies and lowers overall health care costs.

The smart card of the present invention reduces medical errors by providing available and accurate information, expediting diagnosis and onset of treatment. The information is always available even in situations where the patient is unable to answer, thereby accelerating the speed of medical treatment and saving lives in the case of emergencies and is readable by any health care provider such as: ambulance, emergency department, doctors' office, pharmacists, insurance companies, primary doctors, and medical specialists. The present invention also provides continuity of care across different providers and reduces unnecessary, duplicate diagnostic tests and procedures.

Finally, prescriptions that are unreadable and processed incorrectly will now be sent through a secure system directly to the pharmacists and prevent the wrong medication from being processed.

The amount of information supplied on the card can be as much or as little as the cardholder would like, and can even be completely blank save for the patient's name. The card can supply a health care provider such as a caregiver—any licensed paramedic, doctor or pharmacist—with vital medical information such as patient blood type, allergies, medications, and past health history. The system is generally associated with the socialized health care systems largely found in Europe, but the system can be applied to the United States through health insurance companies, if the companies simply replace their standard plastic membership cards with similar plastic cards holding the smart chip. The present invention also provides software for the cards to doctors for free, and when they use it to put in a prescription, the insurance or medication companies could be charged. For example, this proposed method works on a pay by click similar to today's search engine format from Google and Yahoo.

### PREFERRED EMBODIMENT

The present invention teaches the first complete infrastructure solution to optimize the flow of medical data between a doctor, his/her patient, health care provider, and health care locations. Services provided include hosting, a complete software solution (referred to as “the Clinical Application”), portals integration, production and distribution of cards, and operation and integration with a doctor's existing back office system.

The software system of the present invention, in a preferred embodiment, is enabled by a Microsoft Net Framework 3.0 technology with a user friendly interface that is complete configurable by a health care provider, from the PIN security to data retrieval. The system provides easy remote access control via the Internet for all troubleshooting. The system also enables: multiple language capability; an intelligent dynamic search engine, and an optimized process to dictate medical notes ready for offshore transcription. The system fully supports multiple terminals including the use of tablet PCs, making access quick and effective while on the go and provides remote printing and back up of all medical history on the system's central server.

The system also provides means for a fully integrated system for new medical history entry and recordation in an electronic medical record with approval from both the patient and health care provider, and an automated workflow for streamlining electronic medical record entry. Currently, a patient gives their medical history every time they visit health care provider such as a new doctor or medical specialist. Most medical records such as lab reports and images do not travel with the patient to a new doctor and usually another work up must be redone. One method of streamlining medical record entry and dissemination is the fully integrated and automated shortening of lab reports and images including retrieving old medical histories and multiple software support and payment modules for insurance companies. Insurance companies would benefit from these information for the billing process. Finally, the system also includes an intelligent handling of prescription writing and automatic feedback from a pharmacist.

A transcription service provides the voice data in multiple languages or the data can stay as audio dictation from the doctor on the database. Other forms of data, such as lab reports, can be scanned and inputted as a PDF into the application. An email, unique fax number, or other electronic communication means is provided to each doctor for data to be inserted into the correct file by a transcription team. Images can be scanned and stored in Dicom, PDF, jpg, or any other alternative electronic format. The location of storage is dependent on the level of application and can be local or central.

### System's Central Server

The primary terminals of the present invention are the health care provider's PCs located at the health care provider's office in which the health care providers input their cards that are validated with a PIN number. In cases of lost or stolen cards, or if the health care provider needs a new card issued, they can simply call the system's central server and a new card will be sent via signature confirmation mail. Should the need arise where the health care provider needs a back up card, two or more cards can be issued. The responsibility rests with the health care provider to inform the system's central server when a new card is needed. The system's central server is to back-up the data from the individual terminals. With the health care provider's card as the key, the patient's data can be reached by the health care provider via Intranet as well as Internet. Upon request, the data can be transferred to a laptop for the health care provider to use on travel but the health care provider's key card is still needed.

The patient's medical data is stored foremost by their primary care doctor. When data is required, the data is transferred through this primary care doctor with consent of the patient to a specialist via the patient's card or the Internet. This data is accessible by a second doctor via the patient card for small data; large data accessible via the primary care doctor's local server. The primary care doctor's local server is located at the primary care doctor's location, and should that doctor wish to relocate his server, data can be stored at the system's central server location as a back up. The specialist doctor would also be equipped with a primary care doctor's local server to store and carry patient information regarding treatment received. Should this information need to go back to the primary care doctor after new medical records are generated from the specialist, these records will be stored on a patient's smart card. This information can only be retrieved by the primary care doctor if both doctors agree and check a simple box for the transfer of data from the specialist's server to the primary care doctor. The system parallels the present way that paper data is currently transferred. There are two major differences: the system of the present invention is connected to both the Server and primary care doctor PC at all times in order to update the software and the system of the present invention will not store or back up any data unless an agreement has been signed by the treating doctors.

A third party server may also be used by the system of the present invention to provide secondary access to the electronic medical information as well as back-up storage in the event of a system failure so that electronic medical records are not lost or compromised.

### Method of Operation of the Present Invention

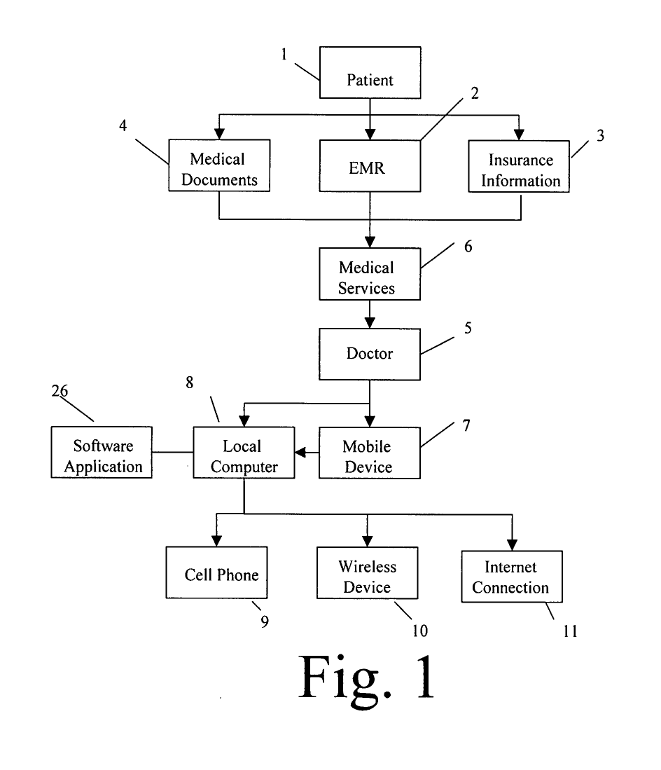

Now referring to FIG. 1, the patient concentric system is illustrated of the present invention is shown and the flow of information is illustrated. The purpose of the software application of the present invention 8 is to securely store, display, organize the EMR at a primary care doctor's office for future visits, storage, billing, insurance audits, and follow up by the primary care doctor of prescribed treatment.

A patient 1 first provides current electronic medical records (also referred to as “EMR”) information 2, insurance information 3, and medical documents 4 to the primary care doctor 5. EMR consists of primary care doctor's notes, dictation, lab reports, and images. Primary care doctor's notes further consist of patient history and medical records.

The primary care doctor then uses the patient's current EMR information 2, insurance information 3, and medical documents 4 to perform medical services 6. The primary care doctor 5 uses his local office computer 8, either directly or through a mobile device 7 such as a tablet PC connected to the primary care doctor's office computer 8 to run and access the software application of the present invention 8 on the local office computer 8. EMR information 2 can then be transferred from the primary care doctor's local office computer 8 via cell phone 9, wireless devices 10, and an Internet connection 11 from the local office computer 8 running the system software acting as a server. This distinguishes the present invention from the prior art, which currently requires that medical records be transferred via paper, mail, fax, or physical file.

In the above method of operation, the example of a primary care doctor is one embodiment of the present invention. In practice any health care provider would use the system in the same manner as the primary care doctor described above. A health care provider consists of, but may not be limited to: emergency medical technicians, nurses, primary care doctors, medical specialists, labs, imaging companies, pharmacists, insurance company, dentist, or anyone associated with the handling, reviewing, updating, or creating of information with or in an electronic medical record.

### SMART CARD EMBODIMENT

In one embodiment, the smart card is manufactured to the ISO 7816 standard and it contains a microprocessor as opposed to just a memory card like those currently known in the prior art. The smart card has an embedded operating system that requires a PIN authorization to access the stored data. Magnetic strip cards offer no security and no storage capacity and normal flash cards do not offer security but offer storage capacity.

The system of the present invention also includes a Software Development Kit (SDK) that enables the operating system of a smart card to work and function as a secured card. With this software development kit (SDK), the system is capable of producing millions of 128K cards under three dollars each, which is half the cost compared to the standard smart cards currently being used in other countries. All caregiver cards are made, produced and sent by a centralized organization. The patient card is made and produced by the system but, in another embodiment, a health insurance company and/or government institutions would provide these cards to their members. In a preferred embodiment the government would provide the card to the uninsured to cover those under Medicare and Medicaid.

With 64 or 128 bit encryption, the smart card operating system has been developed and physically burned on the card. This same technology is currently being used in the US military. The card has an OS burnt on its chip with one or more hard drives such as a C and D drive, similar to a Microsoft Windows OS. Future developments of this card will enhance the security such as multiple chip cards and no contact cards. Several types of sub-categories for health care provider users are currently available on the card but more can be created: Administrators, which includes health care providers such as: doctors that have read and write permissions; administrative users such as: nurses, and office assistants that have select read permissions; and EMTs who have more limited read only permissions. A third sub-category user type is that for the patients, who have read and write permissions over their EMR stored on the card.

Each user has their own level of access for both the clinical application and a patient's smart card. A doctor will have full access to their database of electronic medical records (EMR) stored on the clinical application, which contains the doctor's notes and diagnoses; other health care provider users, such as nurses and office assistants, will have access to emergency registration and billing information and an EMT will be the only people who have access to limited emergency information using only this card to unlock only this special file on the patient's card. Level 1 access will provide: a patient's name, insurance information, and E-prescriptions. Level 2 access will provide: emergency information, doctor contact information, and current medication. Level 3 access will provide: patient medical history, Electronic Medical Records (EPR) and doctor's notes and diagnoses.

There are three types of cards currently available and the capacity of the card will determine the content that it can carry. Similar to our physical keys that we have in our pocket, the information of this key depends on the space given. The first type of key only carries information that unlocks the application to reveal the data on the primary care doctor doctor's computer or a health care provider's computer. Most information will be printed on the card and the memory on the chip will carry the OS. The second and most common type of card is the 128K card that can carry up to 60K of data information. This smart card memory capacity is enough to carry limited information on the card. The third larger capacity flash card comes in 512 MB, 1 GB, 2 GB, 4 GB and 8 GB of data and has a USB connection for faster data transfer. Here, the data is currently encrypted by the card's software and carried on the PC terminal, but has no smart chip. In an alternative embodiment, a combination of the smart card and a flash card will be available to provide means for advance security. Here, radiological images can be carried in large amounts without capacity restrictions.

Due to restraints by the 128K card, the system can currently carry limited information on the card as raw data. Examples of raw data are: image of patient, name, DOB, SSN, insurance carrier, allergies, medications, prescriptions, emergency contact information, etc. There are two types of information on this card: required information such as: image of patient, name and insurance carrier; and elected information that is chosen from a plurality of electronic medical records that the patient has elected to have on his or her card.

The patient will determine what information is on the card; a flyer and advice can be given to the patient to help them with their decision. Most of the EMR on the card can be in form of the ICD-9 or ICD-10 code (International Code of Disease) in order to give a short summary that can be understood by medical practitioners in any language and anywhere in the world.

There are three more technological developments of the smart card that increase the security to the next level and give its users more flexibility. First, an LCD Card is independent from reading terminal cards, and includes thin LCD monitors embedded on a plastic card similar to those that are currently being used in banking for visual verification. Second, a fingerprint card is also available for advanced security cards and card readers that recognize the fingerprint of its owner before the release of medical data will increase security where it is needed. Finally, PDAs and mobile devices have the capability to carry a smart card and have a PIN keyboard build in that enables the security.

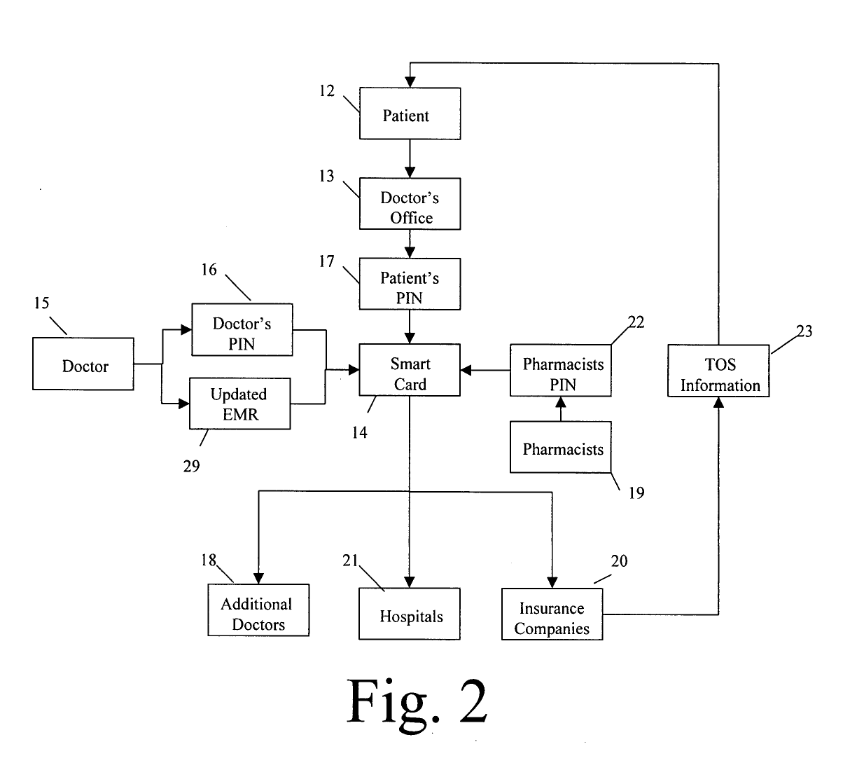

Now referring to FIG. 2, the EMR transfer is illustrated. When a patient 12 visits a doctor's office 13, the patient provides the smart card 14 that is given to the doctor 15 who gains access by use of his PIN 16 with the patient keying in their PIN 17 at the same time. The patient 12 then receives an updated EMR from the doctor 15. The patient 12 can then grant access to his medical information via the smart card 14 through use of his PIN 17 to additional doctors 18, pharmacists 19, insurance companies 20, and hospitals 21. Pharmacists 19 must enter their own PIN 22 to gain access to prescription information on the smart Card 14. In an alternative embodiment, and insurance company 20 provides the smart card 14 to a patient 12 with insurance terms of service information 23.

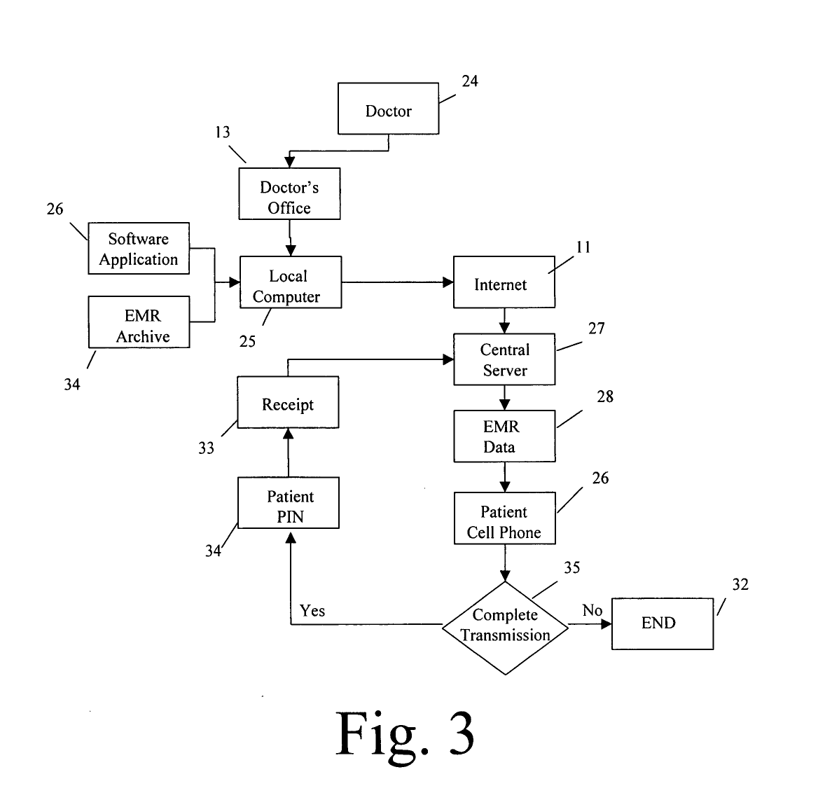

Now referring to FIG. 3, the EMR transfer process of a preferred embodiment of the present invention is illustrated. First a doctor 24 has the system software application 26 installed on a local computer 25 in the doctor's office. The local computer 25 stores EMR archives per HIPPA procedures and standards. For cell phone transfer, a doctor 24 enters a patient's cell phone 26 number and sends data, in an encrypted format, to the patient's cell phone 26 via the Internet to a central system server 27. The central server 27, then forwards the patient information and data to the patients cell phone.

Upon complete transfer of the encrypted EMR data 28 to the patient's cell phone 26, a PIN is needed to be created by the patient to store the EMR data 28 on the patient's cell phone 26 in the cell phone's memory. If less than a complete transfer of the EMR data 28 is received by the patient's cell phone 26, no PIN created is requested to the patient by the patient's cell phone 26 and the central server 27 attempts to resend the complete EMR data 28 to the patient's cell phone 26 and creates an audit trail on the central server recording what information was transferred and what was left out, missing, or unsuccessfully transmitted to the patient's cell phone 26. Upon successful transmission of the complete EMR data 28, the patient's PIN becomes an acknowledgement of receipt of the EMR data 28. The patient's PIN is sent back to the central server 27 in an encrypted format showing data received and stored on the patient's cell phone 26 memory.

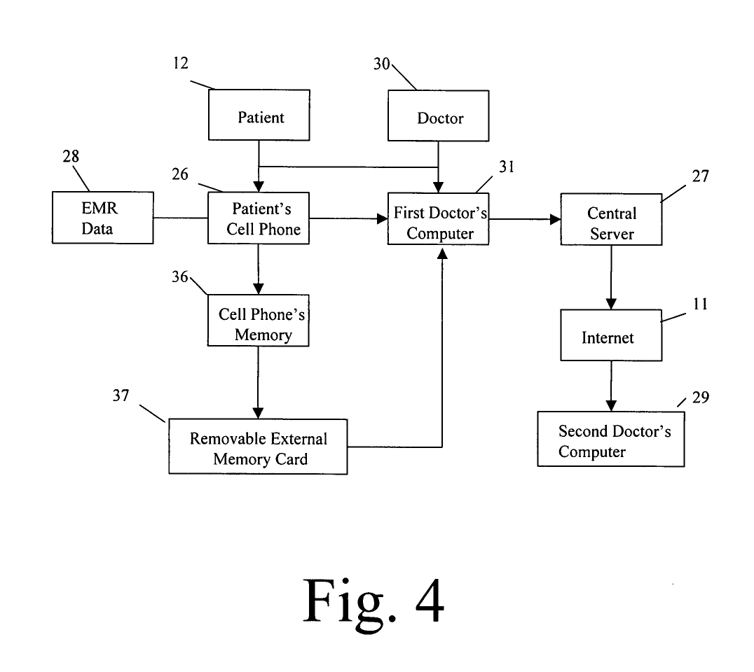

Now referring to FIG. 4, the process of transferring the EMR data 28 from the patient's cell phone 26. In a preferred embodiment there are two preferred methods for transfer of the EMR data 28. A first method is the transfer of the EMR data 28 from the patient's cell phone's memory to a removable external memory card physically located in the cell phone card slot. The second method is to send authorization via the patient's cell phone 26 to the central server 27, which in turn sends the EMR data 28 to a designated doctor's computer 29 via the Internet that can be patient 12 or doctor 30 initiated and occur via USB cord connection from the patient's cell phone 26 to the doctor's computer 31, Bluetooth, WiFi, Infrared, mobile network, SMS, or any equivalent transfer means.

The method of transfer of EMR data 28 from a patient's cell phone 26 starts when the patient 12 enters their PIN on their cell phone keypad to authorize either the cell phone to send the EMR data 28 from the cell phone's memory to an external memory card in an encrypted format or via the central sever 27. Next the external memory card containing the EMR data 28 is removed from the patient's cell phone 26 and is inserted into a USB card reader on a doctor's computer. The software application of the present invention running on the doctor's computer 31 de-crypts the EMR data 28 transferred to the Doctor's computer 31 and displays the date in accordance with the software application's requirements.

If the patient 12 or the doctor 24 chooses the central server transfer option, the patient 12 enters their PIN and the patient's cell phone 26 calls the central server 27 and transmits PIN authorization. The central server 27 then sends the EMR data 28 via the Internet to the doctor's local computer 31. Each software application running on a doctor's computer 31 has a unique ID number for that doctor's office computer 31.

If the doctor 24 initiates the central server transfer option, the doctor 24 requests EMR data 28 from the patient 12 by entering a call to the patient's cell phone 26. The software application running on the doctor's local computer 31 sends an EMR request to the central server 27 via the Internet and the central server 27 calls the patient's cell phone 26 to ask for the PIN and permission to release the EMR data 28 to the doctor's local computer 31 or the patient 12 can elect to send the EMR date 28 from the patient's cell phone 26 to the central server 27 for transfer by the central server 27 via Internet to the doctor's computer 31.

With respect to billing and archiving, the central server 27 can provide command and control and/or archiving and/or billing and/or administrative services to users. The central server 27 can convert ICD 9 codes in English to another desired language, allow discharged military veterans to transfer military medical records, and transfer data between insurance companies.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A system for storing, displaying, and organizing, and transferring of electronic medical records (EMR) to a health care provider, comprising:
a central server running a software application providing means for storing, displaying, and organizing of electronic medical records and accessible by a local computer via a multi-user network;
a health care provider's local office computer running a software application providing a local server and means for storing, displaying, organizing, and transferring electronic medical records;
a patient providing current electronic medical records to a health care provider;
a health care provider using the patient's current electronic medical records, insurance information, and medical documents to perform medical services;
the health care provider using the local office computer, either directly or through a mobile device to run and access a software application on a local office computer;
a health care provider's key card only carrying information to provide access to the system and unlock the software application on the local computer to reveal the data on the health care provider's local computer;
said health care providers key card requires a single PIN authorization to access the stored data stored on the health care provider's local computer;
a patient smart card that contains a microprocessor chip with an embedded chip and operating system which requires a dual PIN authorization process to save or change stored data and a single PIN authorization to access the stored data; and
electronic medical records transferred from the health care provider's local office computer via cell phone, wireless devices, or an Internet connection from the local office computer to a patient's smart card.

2. The system of claim 1 wherein the EMR data consists of health care provider notes, dictation, lab reports, images, patient histories, records, electronic prescriptions, and medical records that are stored and transferred in a plurality of manners.

3. The system of claim 2 wherein the dual PIN authorization process to save or change stored data on a patient smart card consists of:
a health care provider entering a health care provider's key card and the corresponding health care provider's PIN into a reader attached to the health care provider's local computer to key the system and
the patient entering the patient's smart card and the patient's PIN into a reader attached to a health care provider's local computer to grant access by the health care provider;
receiving updated information by the patient on their smart card from the health care provider's local computer; and
using the smart card to provide information to their insurance company, a pharmacy, hospital, doctor, or another health care provider.

4. The system of claim 2 wherein
a health care provider's local office computer acts as a local server;
electronic medical records are transferred from a first health care provider with consent of the patient to a second health care provider via the patient's card or the Internet;
the electronic medical records are accessible by the second health care provider via the patient card for small data with large data being accessible via the server;
said second health care provider also has a local server to store and carry patient information regarding treatment received; and
transferring information from a second health care provider's treatment occurs only when the first and second health care providers agree the transfer of data from the second health care provider's server to the first health care provider's server should occur.

5. The system of claim 1 wherein a cell phone issued to update the smart card or transfer or receive information wherein
a health care provider enters a patient's cell phone number and sends information to the cell phone via the Internet to the central server, which is then sent to the patient's cell phone;
once the information has been transferred to the patients cell phone, the patient enters a PIN to accept and store the information on their cell phone in the cell phone's memory;
entry of the PIN and acknowledgement of receipt of the information is recorded by the server; and
if less than 100% of the information is transmitted, no PIN is requested by the patient and the central server creates a record of what was and what was not transmitted and/or received thereby creating an auditable trail.

6. The system of claim 5 wherein with the information stored on the patient's cell phone there are several methods for transferring the information to the smart card:
using a removable external memory card in the cell phone's card slot and transfer means known in the prior art for transmitting data from the memory card to another electronic storage device; and
sending an authorization from a patient's cell phone to the central server giving permission for the central server to send the information to a health care provider's local computer.

7. The system of claim 1 wherein
a health care provider has their own level of access for both the card and the patient's electronic medical records stored on the card; and
health care providers and access levels specifically include:
a primary care doctor with full access to the electronic medical records stored on the card;
a secondary medical professional, such as any doctor or medical assistant performing medical services, having full access to the electronic medical records stored on the card;
administrators with access to emergency registration and billing information stored on the card; and
an emergency medical technician with access to limited emergency information stored on the card.

8. The system of claim 7 wherein there are three types of cards:
a first type is a key card that only carries information that unlocks the application to reveal the data on a health care provider's computer;
a second type of card is a patient smart card that carries one or more patient electronic medical records; and
a third card type is a patient smart card further comprising a microprocessor chip, flash memory, and connection means for data transfer where said data is encrypted and transferred to an electronic device.

9. The system of claim 8 wherein there are two types of information stored on a card:
required information including image of patient, name and insurance carrier; and
elected information that is chosen from a plurality of electronic medical information that the patient has elected to have on his or her card.

10. The system of claim 8 wherein one or more records comprising the electronic medical records on the card are in stored in the form of the ICD-9 or ICD-10 code and readable in either ICD-9 or ICD-10 code form.

11. The system of claim 10 wherein the smart card is an LCD Card that is independent from reading terminal cards, and includes a thin LCD monitor embedded on the card similar.

12. The system of claim 11 wherein an electronic device has the capability to carry a smart card and have an integrated PIN keyboard.

13. The system of claim 8 wherein the electronic medical record transfer consists of the following steps:
a patient visits a health care provider's office;
the patient provides their smart card to the health care provider;
said health care provider gains read only access by use of the health care provider accessing the system using the health care providers key card and his PIN.

14. The system of claim 13 wherein the electronic medical record transfer consists of the following additional step:
a patient then grants write access to his medical information via the smart card by keying in their PIN while the health care providers key card is active in the system.

15. The system of claim 8 wherein the electronic medical record transfer consists of the following steps:
a health care provider has a system software application installed on a local computer in the health care provider's office;
the local computer stores electronic medical record archives per HIPPA procedures and standards;
for cell phone transfer, a health care provider enters a patient's cell phone number and sends data, in an encrypted format, to the patient's cell phone via the Internet to a central system server;
the central server forwards the patient information and data to the patients cell phone;
upon complete transfer of the encrypted electronic medical record data to the patient's cell phone, a PIN is needed to be created by the patient to store the electronic medical record data on the patient's cell phone in the cell phone's memory;
if less than a complete transfer of the electronic medical record data is received by the patient's cell phone, no PIN created is requested to the patient by the patient's cell phone and the central sever attempts to resend the complete electronic medical record data to the patient's cell phone and creates an audit trail on the central server recording what information was transferred and what was left out, missing, or unsuccessfully transmitted to the patient's cell phone;
upon successful transmission of the complete electronic medical record data, the patient's PIN becomes an acknowledgement of receipt of the electronic medical record data; and
the patient's PIN is sent back to the central server in an encrypted format showing data received and stored on the patient's cell phone memory.

16. The system of claim 15 wherein transferring the electronic medical record data from the patient's cell phone consists of transferring of the electronic medical record data from the patient's cell phone's memory to a removable external memory card physically located in the cell phone card slot.

17. The system of claim 15 wherein transferring the electronic medical record data from the patient's cell phone consists of sending authorization via the patient's cell phone to the central server, which in turn sends the electronic medical record data to a designated health care provider's computer via the Internet that can be patient or health care provider initiated and occur via corded or wireless transfer means.

18. The system of claim 16 wherein transferring the electronic medical record data from the patient's cell phone consists of the following additional steps:
the process starts when the patient enters their PIN on their cell phone keypad to authorize either the cell phone to send the electronic medical record data from the cell phone's memory to an external memory card in an encrypted format or via the central sever;
the external memory card containing the electronic medical record data is removed from the patient's cell phone and is inserted into a USB card reader on a health care provider's computer; and
the software application running on the health care provider's computer de-crypts the electronic medical record data transferred to the health care provider's computer and displays the date in accordance with the software application's requirements.

19. The system of claim 15 wherein transferring the electronic medical record data from the central server consists of the following steps:
the patient enters their PIN and the patient's cell phone calls the central server and transmits PIN authorization;
the central server then sends the electronic medical record data via the Internet to the health care provider's local computer; and
each software application running on a health care provider's computer has a unique ID number for that health care provider's office computer.

20. The system of claim 19 wherein when a health care provider initiates the central server transfer option transferring the electronic medical record data from the central server, the process consists of the following steps:
the health care provider requests electronic medical record data from the patient by entering a call to the patient's cell phone;
the software application running on the health care provider's local computer sends an electronic medical record request to the central server via the Internet; and
the central server calls the patient's cell phone to ask for the PIN and permission to release the electronic medical record data to the health care provider's local computer or the patient can elect to send the electronic medical record date from the patient's cell phone to the central server for transfer by the central server via Internet to the health care provider's computer.
